(19) United States
(12) Patent Application Publication
(10) Pub. No.: US 2007/0171086 A1
(43) Pub. Date: Jul. 26, 2007

(54) Environmental monitor

(76) Inventor: Christian L. Belady, Richardson, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,847

(22) Filed: Oct. 26, 2005

(51) Int. Cl. G08B 21/00

(52) U.S. Cl. 340/665

(57) ABSTRACT

A floor tile body containing a plurality of openings (such as those commonly used in computer data centers) is built to include at least one air parameter sensor. The one or more sensors are electrically coupled with control electronics where their raw data is converted into air parameters such as temperature, humidity, pressure, and air flow velocity or volume. Optionally, the control electronics may communicate with a computer for data logging or a display.

### BACKGROUND OF THE INVENTION

Densification in data centers is becoming so extreme that the power density of the systems in the center is growing at a rate unmatched by technology developments in data center heating, ventilation, and air-conditioning (HVAC) designs. Current servers and disk storage systems generate 10,000 to 20,000 watts per square meter of footprint. Telecommunication equipment may generate two to three times the heat of the servers and disk storage systems. Liquid-cooled equipment could solve this heat transfer problem, however, there is reluctance by both end users and computer manufacturers to make the transition from air-cooled computers to liquid-cooled computers. Thus, many data centers remain air-cooled.

Many modem data centers utilize a system utilizing a raised floor configured as a supply air plenum. Large HVAC units take air from near the ceiling of the data center, chill the air, and blow the cold air into the plenum under the raised floor. Vents in the floor tiles near the servers allow cold air to be pulled up from the plenum, through the rack and the now warm air is blown out the back of the rack where it rises to the ceiling and eventually is pulled in to the HVAC units to begin the cycle anew. However, this type of system is limited in that it can only handle power of about 1600 to 2100 watts per square meter. Further complicating matters, air flow and temperature may vary within the data center due to differing paths traveled by the cooling air, and differing distances between the HVAC units and the heat generating equipment. Data centers often contain significant amounts of empty space to ensure that air flow is capable of reaching all of the equipment in sufficient volumes for cooling the equipment. Also, use of the under floor plenum has difficulties in that airflow is often impeded by cabling and other obstructions residing in the plenum. This may cause still further unpredictable variations in air flow and in air temperature across the data center floor. Balancing the airflow throughout the data center is difficult, and often requires a substantial amount of trial and error experimentation. Currently, airflow and air temperature measurements throughout a data center require the use of hand held or large bulky metering devices. In fact, in measuring airflow, some of the metering devices themselves may alter the airflow resulting in inaccurate readings.

Because data center airflow analysis is time-consuming and difficult, managers may neglect to measure changes in the data center atmosphere caused by the addition or movement of computers within the data center. This may result in an imbalance in atmospheric conditions, causing some computers to run at higher temperatures than other computers, possibly to the point of failure.

### SUMMARY OF THE INVENTION

A floor tile body containing a plurality of openings (such as those commonly used in computer data centers) is built to include at least one air parameter sensor. The one or more sensors are electrically coupled with control electronics where their raw data is converted into air parameters such as temperature, humidity, pressure, and air flow velocity or volume. Optionally, the control electronics may communicate with a computer for data logging or a display.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a top view of an example embodiment of a floor tile including environmental monitoring capability according to the present invention.

FIG. 2 is a close up top view of a portion of the example embodiment of a floor tile including environmental monitoring capability from FIG. 1 according to the present invention.

FIG. 3 is a flow chart of an example embodiment of a method for constructing an environmental monitor according to the present invention.

### DETAILED DESCRIPTION

This description of the preferred embodiments is intended to be read in connection with the accompanying drawings, which are to be considered part of the entire written description of this invention. In the description, relative terms such as “lower,” “upper,” “horizontal,” “vertical,” “up,” “down,” “top,” “bottom,” “left,” and “right” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected,” “coupled,” and “interconnected,” refer to a relationship wherein structures are secured or attached to one another either directly or indirectly through intervening structures, as well as both movable or rigid attachments or relationships, unless expressly described otherwise.

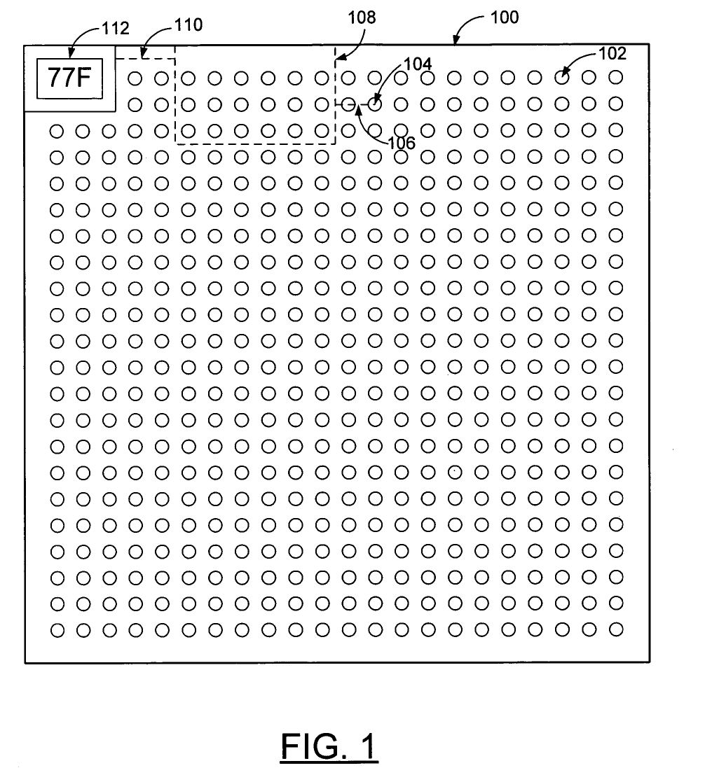

FIG. 1 is a top view of an example embodiment of a floor tile including environmental monitoring capability according to the present invention. In this example embodiment of the present invention, a floor tile body 100 is shown including a plurality of openings 102 between an upper surface and a lower surface of said floor tile body. In this example, the openings 102 are circular in cross-section however those of skill in the art will recognize that these openings may be any shape within the scope of the present invention. For example, other embodiments may use a grid or grate set within the floor tile body 100 to provide the plurality of openings 102. An environmental sensor 104 is placed within one of the openings 102 in the floor tile body 100. This environmental sensor 104 may measure any characteristic of the air flowing through the floor tile body 100 such as temperature, pressure, flow rate, and humidity. The environmental sensor 104 is electrically coupled to control electronics 108 by a cable 106 containing one or more wires in this example embodiment of the present invention. Those of skill in the art will recognize that the environmental sensor 104 may use any of a wide variety of methods to communicate data to the control electronics. For example, other embodiments of the present invention may use wireless or IR techniques to couple the environmental sensor 104 to the control electronics 108. This example embodiment of the present invention also includes a display 112 built into the floor tile body 100 and electrically coupled to the control electronics 108 by a cable 110 containing one or more wires. As with the environmental sensor 104, a wide variety of methods may be used to couple the display 112 to the control electronics 108. The control electronics 108 is configured to receive data from the environmental sensor 104 and convert the measurement from the sensor 104 into a parameter of the air flowing through the floor tile, such as a temperature, pressure, velocity, volume, or humidity reading. This parameter is then sent to the display 112 where it may be read by a user. Alternatively, the control electronics 108 may be in communication with a computer (possibly external to the floor tile, and not shown) where these parameters may be stored for later use. This communication may take place over an electrical connection such as a cable or via wireless or IR or any other of the many methods of electronic communication known in the art.

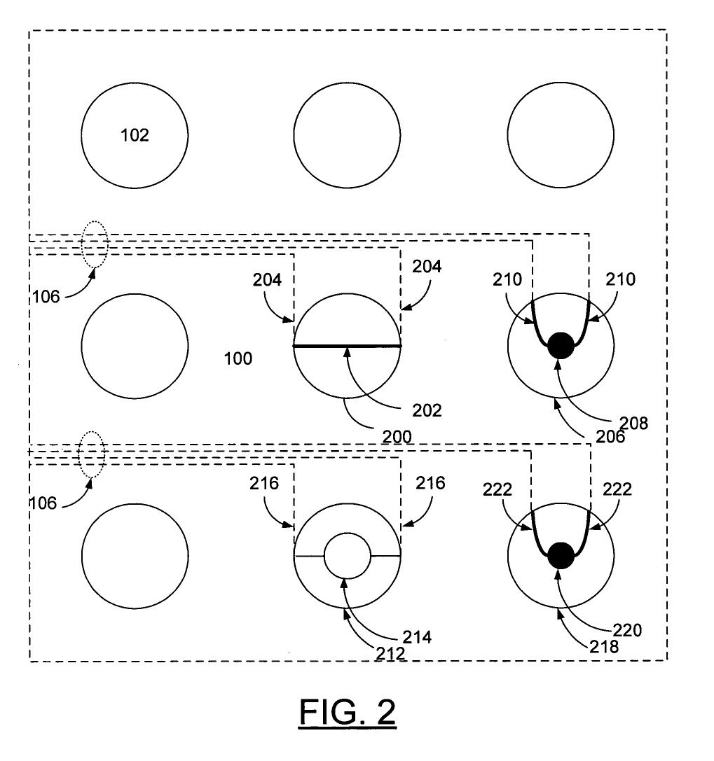

FIG. 2 is a close up top view of a portion of the example embodiment of a floor tile including environmental monitoring capability from FIG. 1 according to the present invention. In this example embodiment of the present invention, a floor tile body 100 includes a plurality of openings 102. Environmental sensors 104 have been placed in four of the openings 102. In a first opening 200, an air flow sensor 200 has been mechanically coupled with the floor tile body in a configuration to measure the quantity and/or velocity of the air flow through the floor tile opening. The air flow sensor 200 is electrically coupled with two wires 202 of a cable 106 electrically coupled with the control electronics 108 of FIG. 1. Those of skill in the art will recognize that there are a wide variety of methods and apparatus usable to measure air volume and/or velocity all within the scope of the present invention. In this example embodiment, a hot wire anemometer 200 is used for air flow measurement, however, other embodiments may use other devices. The air flow data from the anemometer may take any of a wide variety of characteristics within the scope of the present invention. For example, in one embodiment a voltage proportional to measured air velocity may be communicated to the control electronics 108 through the cable. The floor tile including the anemometer may be calibrated to provide air volume per unit time (typically cubic feet per minute (CFM)) instead of air velocity measurements. The control electronics 108 may then convert a voltage from the anemometer to a velocity or a volume per unit time measurement for communication to a computer or for display 112.

In a second opening 206, an air temperature sensor 208 has been mechanically coupled with the floor tile body in a configuration to measure the temperature of the air flowing through the floor tile opening. The air temperature sensor 208 is electrically coupled with two wires 210 of a cable 106 electrically coupled with the control electronics 108 of FIG. 1. Those of skill in the art will recognize that there are a wide variety of methods and apparatus usable to measure air temperature all within the scope of the present invention. In this example embodiment, a thermocouple 208 is used for air temperature measurement, however, other embodiments may use other devices. The air temperature data from the air temperature sensor may take any of a wide variety of characteristics within the scope of the present invention. For example, in one embodiment a voltage proportional to measured air temperature may be communicated to the control electronics 108 through the cable. The control electronics 108 may then convert the voltage to a temperature measurement for communication to a computer or for display 112.

In a third opening 212, an air pressure sensor 214 has been mechanically coupled with the floor tile body in a configuration to measure a pressure of the air flowing through the floor tile opening. This air pressure sensor 214 may measure the absolute pressure of the air either above or below the floor tile, or may measure the differential air pressure between the upper and lower surfaces for the floor tile all within the scope of the present invention. The air pressure sensor 214 is electrically coupled with two wires 216 of a cable 106 electrically coupled with the control electronics 108 of FIG. 1. Those of skill in the art will recognize that there are a wide variety of methods and apparatus usable to measure air pressure all within the scope of the present invention. Those of skill in the art will also recognize that while this embodiment of the present invention includes two wires connecting the sensor to the control electronics, other embodiments may use any number of wires or signals all within the scope of the present invention. In this example embodiment, a differential air pressure diaphragm 208 is used for a differential air pressure measurement, however, other embodiments may use other devices. The air pressure data from the air pressure sensor may take any of a wide variety of characteristics within the scope of the present invention. For example, in one embodiment a voltage proportional to measured differential air pressure may be communicated to the control electronics 108 through the cable. The control electronics 108 may then convert the voltage to a pressure measurement for communication to a computer or for display 112.

In a fourth opening 218, an air humidity sensor 220 has been mechanically coupled with the floor tile body in a configuration to measure the humidity of the air flowing through the floor tile opening. The air humidity sensor 208 is electrically coupled with two wires 222 of a cable 106 electrically coupled with the control electronics 108 of FIG. 1. Those of skill in the art will recognize that there are a wide variety of methods and apparatus usable to measure air humidity all within the scope of the present invention. In this example embodiment, a hygrometer 208 is used for air temperature measurement. The air humidity data from the air humidity sensor may take any of a wide variety of characteristics within the scope of the present invention. For example, in one embodiment a voltage proportional to measured air humidity may be communicated to the control electronics 108 through the cable. The control electronics 108 may then convert the voltage to a humidity measurement for communication to a computer or for display 112.

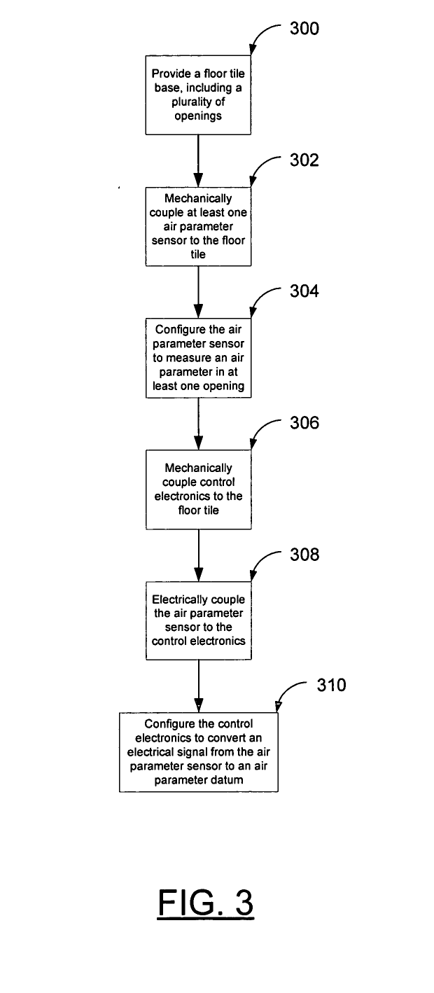

FIG. 3 is a flow chart of an example embodiment of a method for constructing an environmental monitor according to the present invention. In a step 300, a floor tile base including a plurality of openings between an upper surface and a lower surface of the floor tile body is provided. These openings in the floor tile may be holes or a grating or any other opening in the floor tile within the scope of the present invention. In a step 302, at least one air parameter sensor is mechanically coupled to the floor tile. Those of skill in the art will recognize that a very wide variety of air parameter sensors may be used in this step within the scope of the present invention. Example air parameter sensors such as anemometers, hygrometers, pressure sensors, and thermometers have been described above, however any air parameter sensor may be used within the scope of the present invention. In a step 304, the at least one air parameter sensor is configured to measure an air parameter in at least one of the plurality of openings. In a step 306, control electronics is mechanically coupled to the floor tile. In a step 308, the at least one air parameter sensor is electrically coupled to the control electronics. In a step 310, the control electronics is configured to convert an electrical signal from the air parameter sensor to an air parameter datum. Those of skill in the art will recognize that this electronic signal may take many different forms (such as a voltage or a current) all within the scope of the present invention.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device comprising:
a floor tile body, wherein said floor tile body includes a plurality of openings between an upper surface and a lower surface of said floor tile body;
an air parameter sensor, mechanically coupled with said floor tile body, configured to measure a parameter of air flowing through at least one of said openings; and
control electronics, electrically coupled with said air parameter sensor, configured to convert an electrical output of said air parameter sensor to a air parameter datum.

2. The device recited in claim 1,
wherein said air parameter sensor is a thermocouple and said air parameter datum is a temperature datum.

3. The device recited in claim 2, further comprising:
a display, electrically coupled with said control electronics, configured to display said temperature datum.

4. The device recited in claim 3,
wherein said display is mechanically coupled with said floor tile body.

5. The device recited in claim 2,
wherein said control electronics is mechanically coupled with said floor tile body.

6. The device recited in claim 2,
wherein said control electronics is electrically coupled with a computer.

7. The device recited in claim 2,
wherein said thermocouple is positioned within one of said openings in said floor tile body.

8. The device recited in claim 2,
wherein said control electronics is in wireless communication with a computer.

9. The device recited in claim 1,
wherein said air parameter sensor is an anemometer and said air parameter datum is an air velocity datum.

10. The device recited in claim 9, further comprising:
a display, electrically coupled with said control electronics, configured to display said air velocity datum.

11. The device recited in claim 10,
wherein said display is mechanically coupled with said floor tile body.

12. The device recited in claim 9,
wherein said control electronics is mechanically coupled with said floor tile body.

13. The device recited in claim 9,
wherein said control electronics is electrically coupled with a computer.

14. The device recited in claim 9,
wherein said anemometer is positioned within one of said openings in said floor tile body.

15. The device recited in claim 9,
wherein said control electronics is in wireless communication with a computer.

16. The device recited in claim 9,
wherein said anemometer is a hot wire anemometer.

17. The device recited in claim 1,
wherein said air parameter sensor is an anemometer and said air parameter datum is an air volume per unit time datum.

18. The device recited in claim 17, further comprising:
a display, electrically coupled with said control electronics, configured to display said air volume per unit time datum.

19. The device recited in claim 18,
wherein said display is mechanically coupled with said floor tile body.

20. The device recited in claim 17,
wherein said control electronics is mechanically coupled with said floor tile body.

21. The device recited in claim 17,
wherein said control electronics is electrically coupled with a computer.

22. The device recited in claim 17,
wherein said anemometer is positioned within one of said openings in said floor tile body.

23. The device recited in claim 17,
wherein said control electronics is in wireless communication with a computer.

24. The device recited in claim 17,
wherein said anemometer is a hot wire anemometer.

25. The device recited in claim 1,
wherein said air parameter sensor is an air pressure sensor and said air parameter datum is an air pressure datum.

26. The device recited in claim 25, further comprising:
a display, electrically coupled with said control electronics, configured to display said air pressure datum.

27. The device recited in claim 26,
wherein said display is mechanically coupled with said floor tile body.

28. The device recited in claim 25,
wherein said control electronics is mechanically coupled with said floor tile body.

29. The device recited in claim 25,
wherein said control electronics is electrically coupled with a computer.

30. The device recited in claim 25,
wherein said air pressure sensor is positioned within one of said openings in said floor tile body.

31. The device recited in claim 25,
wherein said control electronics is in wireless communication with a computer.

32. The device recited in claim 1,
wherein said air parameter sensor is an air humidity sensor and said air parameter datum is an air humidity datum.

33. The device recited in claim 32, further comprising:
a display, electrically coupled with said control electronics, configured to display said air humidity datum.

34. The device recited in claim 33,
wherein said display is mechanically coupled with said floor tile body.

35. The device recited in claim 32,
wherein said control electronics is mechanically coupled with said floor tile body.

36. The device recited in claim 32,
wherein said control electronics is electrically coupled with a computer.

37. The device recited in claim 32,
wherein said air humidity sensor is positioned within one of said openings in said floor tile body.

38. The device recited in claim 32,
wherein said control electronics is in wireless communication with a computer.

39. A method comprising the steps of:
a) providing a floor tile base, including a plurality of openings between an upper surface and a lower surface of said floor tile body;
b) mechanically coupling an air parameter sensor to the floor tile base;
c) configuring the air parameter sensor to measure a parameter of air flowing through at least one of the openings in the floor tile base;
d) electrically coupling the air parameter sensor to the control electronics; and
e) configuring the control electronics to convert an electrical output from the air parameter sensor to an air parameter datum.

40. The method recited in claim 39,
wherein said air parameter sensor is a thermocouple and said air parameter datum is a temperature datum.

41. The method recited in claim 40, further comprising the step of:
f) electrically coupling the display to the control electronics; and
g) configuring the display to display the temperature datum.

42. The method recited in claim 41, further comprising the step of:
h) mechanically coupling the display to the floor tile base.

43. The method recited in claim 40, further comprising the step of:
f) mechanically coupling the control electronics to the floor tile base.

44. The method recited in claim 40, further comprising the step of:
f) electrically coupling the control electronics to a computer.

45. The method recited in claim 40, further comprising the step of:
f) positioning the thermocouple within one of the openings in the floor tile body.

46. The method recited in claim 40, further comprising the step of:
f) coupling the control electronics to a computer via wireless communication.

47. The method recited in claim 39,
wherein said air parameter sensor is an anemometer and said air parameter datum is an air velocity datum.

48. The method recited in claim 47, further comprising the step of:
f) electrically coupling the display to the control electronics; and
g) configuring the display to display the velocity datum.

49. The method recited in claim 48, further comprising the step of:
h) mechanically coupling the display to the floor tile base.

50. The method recited in claim 47, further comprising the step of:
f) mechanically coupling the control electronics to the floor tile base.

51. The method recited in claim 47, further comprising the step of:
f) electrically coupling the control electronics to a computer.

52. The method recited in claim 47, further comprising the step of:
f) positioning the anemometer within one of the openings in the floor tile body.

53. The method recited in claim 47, further comprising the step of:
f) coupling the control electronics to a computer via wireless communication.

54. The method recited in claim 47,
wherein the anemometer is a hot wire anemometer.

55. The method recited in claim 39,
wherein said air parameter sensor is an anemometer and said air parameter datum is an air volume per unit time datum.

56. The method recited in claim 39,
wherein said air parameter sensor is an air humidity sensor and said air parameter datum is an air humidity datum.

57. The method recited in claim 39,
wherein said air parameter sensor is an air pressure sensor and said air parameter datum is an air pressure datum.

58. A device comprising:
a floor tile body, including means for allowing the passage of air from a lower surface to an upper surface of said floor tile body;
means for measuring a parameter of air passing through the floor tile body; and
means for displaying the measurement datum.

59. The device recited in claim 58,
wherein said parameter is a temperature and said measurement datum is a temperature datum.

60. The device recited in claim 58,
wherein said parameter is an air velocity and said measurement datum is an air velocity datum.

61. The device recited in claim 58,
wherein said parameter is an air volume per unit time and said measurement datum is an air volume per unit time datum.

62. The device recited in claim 58,
wherein said parameter is a humidity and said measurement datum is a humidity datum.

63. The device recited in claim 59,
wherein said parameter is an air pressure and said measurement datum is an air pressure datum.
